(19) United States
(12) Patent Application Publication
(10) Pub. No.: US 2006/0249029 A1
(43) Pub. Date: Nov. 9, 2006

(54) Fermentation apparatus for customizing fermentation level and method thereof

(75) Inventors: Kyung-hee Hahm, Seoul (KR); Jeong-han Kim, Suwon-si (KR); Jae-seung Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/331,007

(22) Filed: Jan. 13, 2006

(30) Foreign Application Priority Data
May 3, 2005 (KR) 10-2005-37144

(51) Int. Cl. A23L 1/00

(52) U.S. Cl. 99/275

(57) ABSTRACT

A fermentation apparatus including a storage compartment which is formed with an accommodating space for storing food, further including a fermentation part to ferment food in the storage compartment; a fermentation condition setting part to select an initial fermentation condition of the food; an input part having a memory button to memorize a fermentation condition at a desired fermentation level if the food fermented according to the initial fermentation condition is at the predetermined fermentation level; and a controller to control the fermentation part, and store fermentation time from the start of the fermentation to the selection of the memory button and fermentation temperature at each fermentation time, as a custom fermentation condition when the memory button is selected. Thus, a fermentation apparatus for customizing a fermentation level and a method thereof is provided, which memorizes a desired fermentation level and repeatedly provides food at a desired fermentation level by selecting a memorized fermentation level.

### CROSS-REFERENCE TO RELATED APPLICATIONS

This application claims the benefit of Korean Patent Application No. 10-2005-0037144, filed on May 3, 2005, in the Korean Intellectual Property Office, the disclosure of which is incorporated herein by reference.

### BACKGROUND OF THE INVENTION

1. Field of the Invention

The present invention relates to a fermentation apparatus for customizing a fermentation level and a method thereof.

2. Description of the Related Art

Generally, foods such as wine, soybean paste, soy sauce, kimchi, vinegar, cheese etc. are fermented under predetermined periods of time, temperature, humidity, etc. to add flavor and taste in the manufacturing process.

The fermentation method varies according to the food to be fermented. For example, kimchi was conventionally stored in a container such as a kimchi jar and buried in the ground, or kept for a predetermined period of time at room temperature. However, a kimchi refrigerator has been widely used for fermenting kimchi recently. Korean Patent Application No. 1998-0055876 discloses the general configuration of a kimchi refrigerator.

There are two methods in fermenting and refrigerating kimchi stored in the kimchi refrigerator: manual fermentation in which a user directly inputs desired fermentation temperature and time to the kimchi refrigerator; and automatic fermentation in which a user selects an automatic fermentation button preset with fermentation conditions according to the kind of kimchi and fermentation levels to ferment kimchi into the selected fermentation level and refrigerate kimchi in a refrigeration mode.

However, when fermenting kimchi in the foregoing manual fermentation method, a user should repeatedly check the taste or smell of kimchi to see if it is being fermented as a user wants.

Also, even though the kimchi refrigerator having the automatic fermentation function provides at least one automatic fermentation button preset with the fermentation conditions of the fermented food, it is uniformly set with types and fermentation levels of the fermented food while being manufactured, thereby providing a limited range of fermentation levels and repeatedly causing inconvenience in the conventional fermentation method if the provided fermentation level does not meet a user's demand.

### SUMMARY OF THE INVENTION

Accordingly, it is an aspect of the present invention to provide a fermentation apparatus for customizing a fermentation level and a method thereof, which memorizes a desired fermentation level and repeatedly provides food at a desired fermentation level by selecting a memorized fermentation level.

Additional aspects and/or advantages of the present invention will be set forth in part in the description which follows and, in part, will be apparent from the description, or may be learned by practice of the present invention.

The foregoing and/or other aspects of the present invention are also achieved by providing a fermentation apparatus including a storage compartment which is formed with an accommodating space for storing food, further including a fermentation part to ferment food in the storage compartment; a fermentation condition setting part to select an initial fermentation condition of the food; an input part having a memory button to memorize a fermentation condition at a desired fermentation level if the food fermented according to the initial fermentation condition is at the predetermined fermentation level; and a controller to control the fermentation part, and store fermentation time from the start of the fermentation to the selection of the memory button and fermentation temperature at each fermentation time, as a custom fermentation condition when the memory button is selected.

According to an aspect of the present invention, the fermentation condition setting part includes a fermentation temperature setting button to set the fermentation temperature of the food and a fermentation time setting button to set the fermentation time of the food.

According to an aspect of the present invention, the fermentation condition setting part includes an automatic fermentation button which is stored with the fermentation time according to the kind of the food and a desired fermentation level and the fermentation temperature according to the fermentation time.

According to an aspect of the present invention, the fermentation apparatus further includes a memory display part to display that the custom fermentation condition is stored, wherein the controller controls the memory display part to display that the custom fermentation condition is stored when the memory button is selected.

According to an aspect of the present invention, the controller stores a plurality of custom fermentation conditions.

According to an aspect of the present invention, the input part is provided with the memory button and the memory display part corresponding to the number of the stored custom fermentation conditions.

According to an aspect of the present invention, the input part is provided with a memory button and a plurality of memory display parts corresponding to the number of the custom fermentation conditions.

According to an aspect of the present invention, the controller controls the fermentation part to complete the fermentation of the food and convert it into a refrigeration mode when the memory button is selected.

According to an aspect of the present invention, the fermentation part includes at least one of a heating part to heat the storage compartment and a cooling part to cool the storage compartment.

According to an aspect of the present invention, the fermentation apparatus further includes a temperature sensor to sense temperature of the storage compartment and a timer to count the fermentation time of the food stored in the storage compartment, wherein the controller controls the fermentation part to ferment the food according to the custom fermentation condition on the basis of a result sensed by the temperature sensor and the fermentation time counted by the timer if selecting the custom fermentation condition with the memory button.

According to an aspect of the present invention, the controller controls the fermentation part to automatically convert the food into the refrigeration mode if the fermentation of the food is completed according to the custom fermentation condition.

According to an aspect of the present invention, the fermentation apparatus further includes an alarm to notify a user that the fermentation of the food is completed by the controller if the fermentation of the food is completed according to the custom fermentation condition.

The foregoing and/or other aspects of the present invention are also achieved by providing a fermentation apparatus including a storage compartment which is formed with an accommodating space for storing food, further including a fermentation part to ferment food in the storage compartment; a fermentation condition setting part to select an initial fermentation condition of the food; an input part having at least one memory button to memorize a fermentation condition at a predetermined fermentation level if the food fermented according to the initial fermentation condition is at the predetermined fermentation level; a memory to be stored with the fermentation condition; and a controller to control the fermentation part, and store fermentation time from the start of the fermentation to the selection of the memory button and fermentation temperature at each fermentation time, as a custom fermentation condition, in the memory when the memory button is selected.

According to an aspect of the present invention, the fermentation condition setting part includes at least one of a fermentation temperature setting button and an automatic fermentation button.

According to an aspect of the present invention, the fermentation apparatus further includes a memory display part to display that the custom fermentation condition is stored in the memory, wherein the controller displays on the memory display part that the custom fermentation condition is stored when the memory button is selected.

According to an aspect of the present invention, the memory is stored with a plurality of custom fermentation conditions by the controller.

According to an aspect of the present invention, the controller controls the fermentation part to complete the fermentation of the food and convert it into a refrigeration mode when the memory button is selected.

According to an aspect of the present invention, the fermentation part includes at least one of a heating part to heat the storage compartment and a cooling part to cool the storage compartment.

According to an aspect of the present invention, the fermentation apparatus further includes a temperature sensor to sense temperature of the storage compartment and a timer to count the fermentation time of the food stored in the storage compartment, wherein the controller controls the fermentation part to ferment the food according to the custom fermentation condition on the basis of a result sensed by the temperature sensor and the fermentation time counted by the timer if selecting the custom fermentation condition with the memory button.

According to an aspect of the present invention, the controller controls the fermentation part to automatically convert the food into the refrigeration mode if the fermentation of the food is completed according to the custom fermentation condition.

According to an aspect of the present invention, the fermentation apparatus further includes an alarm to notify a user that the fermentation of the food is completed by the controller if the fermentation of the food is completed.

The foregoing and/or other aspects of the present invention are also achieved by providing a custom fermentation method to memorize fermentation time and fermentation temperature of food at each fermentation time and store them as a custom fermentation condition, including storing food in a storage compartment to ferment it; setting the fermentation time and temperature as an initial fermentation condition of the food in the storage compartment; fermenting the food in the storage compartment according to the initial fermentation condition; counting the fermentation time of the food and storing the fermentation temperature at each fermentation time as the fermentation condition; selecting a memory button to memorize the fermentation condition at each fermentation level if the food reaches a predetermined fermentation level; and storing the fermentation condition as the custom fermentation condition when the memory button is selected.

According to an aspect of the present invention, the custom fermentation method further includes completing the fermentation of the food and converting into a refrigeration mode automatically when the memory button is selected.

According to an aspect of the present invention, the custom fermentation method further includes restoring food in the storage compartment to ferment it; selecting the stored custom fermentation condition through the memory button; and fermenting the food in the storage compartment according to the custom fermentation condition.

According to an aspect of the present invention, the custom fermentation method further includes completing the fermentation of the food and converting into the refrigeration mode automatically if the fermentation of the food is completed according to the custom fermentation condition.

According to an aspect of the present invention, the custom fermentation method further includes notifying a user that the fermentation of the food is completed.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a configuration block diagram of a fermentation apparatus according to the present invention;

FIG. 2 is a sectional view of the fermentation apparatus in FIG. 1;

FIGS. 3 through 6 illustrate various embodiments of an input part and a display part of the fermentation apparatus in FIG. 1; and

FIGS. 7 and 8 are control flow charts of a custom fermentation method according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Reference will now be made in detail to the embodiments of the present invention, examples of which are illustrated in the accompanying drawings, wherein like reference numerals refer to like elements throughout.

A kimchi refrigerator will be described as an example of the present invention, but not limited thereto. The present invention may be applicable to a fermentation apparatus or a storage apparatus for fermented food.

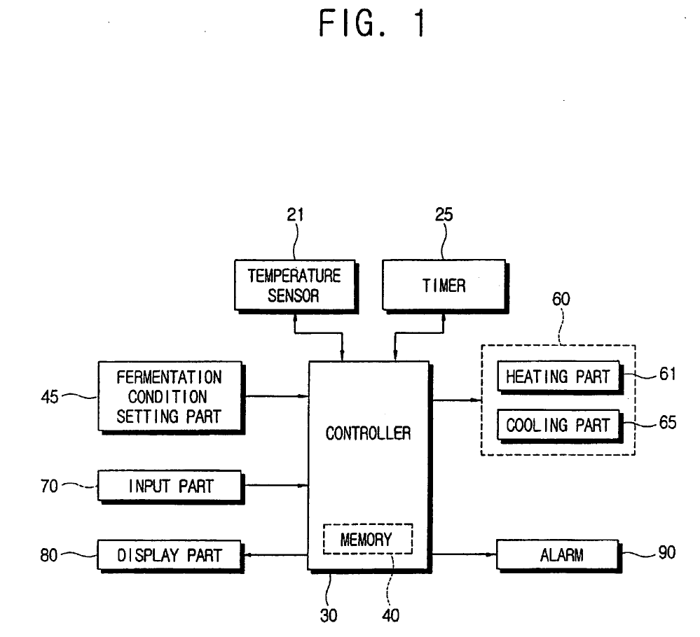

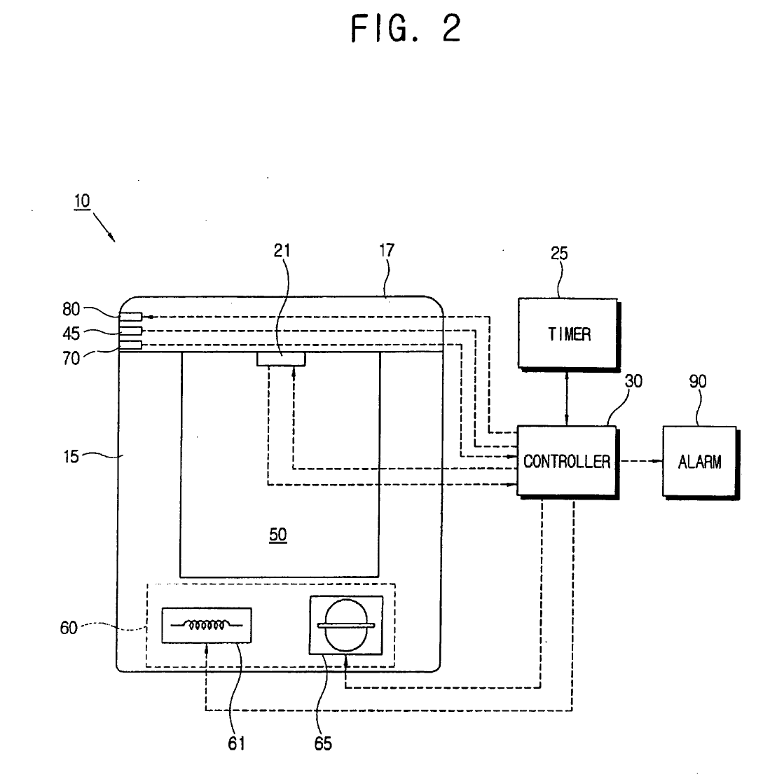

Referring to FIGS. 1 and 2, a fermentation apparatus 10 according to the present invention includes a storage compartment 50, a fermentation part 60 to heat and cool the storage compartment 50, a fermentation condition setting part 45, an input part 70 and a controller 30. The fermentation apparatus 10 may further include a temperature sensor 21, a timer 25, a display part 80, an alarm 90 and a memory 40.

The storage compartment 50 forms an accommodating space to store food in a main body 15. The storage compartment 50 may be provided as single or plural compartments in the main body 15, as necessary. If the storage compartment 50 is plurally provided, each of the compartments 50 is divided by an insulating material. The compartments 50 may operate uniformly as a whole, or perform fermentation and refrigeration functions independently.

The fermentation part 60 is provided as at least one of a heating part 61 and a cooling part 65 to ferment and refrigerate food in the storage compartment 50. For example, if room temperature is lower than the fermentation and refrigeration temperature, only the heating part 61 may be provided. If the room temperature is higher than the fermentation and refrigeration temperature, only the cooling part 65 may be provided. Alternatively, both the heating part 61 and the cooling part 65 may be provided to ferment and refrigerate food. Here, the heating part 61 may be provided as an electric resistance heating element, but not limited thereto. The cooling part 65 may include a cooling cycle having a compressor. At this time, an outer wall of the respective storage compartments 50 is surrounded by a refrigerant pipe and a heater.

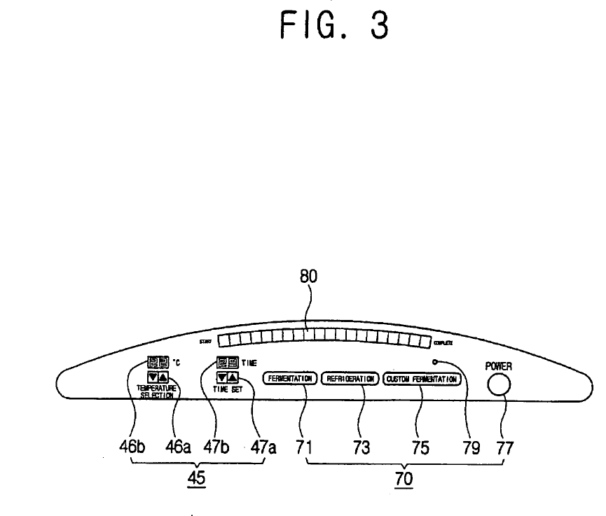

The fermentation condition setting part 45 is provided to set initial fermentation conditions of food in the storage compartment 50. As shown in FIGS. 3 through 5, the fermentation condition setting part 45 may be provided with a fermentation temperature setting button 46a through which a user directly sets fermentation temperature and time; and a fermentation temperature display part 46b to display a set fermentation temperature. The configuration and display of the fermentation condition setting part 45 is not limited to the example shown in FIG. 3, and may be provided in various ways. For example, a single fermentation temperature setting button 46a may be provided to change the fermentation temperature by being pressed several times repeatedly. Alternatively, buttons, which are numbered from 0 to 9, may be provided to be directly input with the fermentation temperature. The fermentation temperature display part 46b may display the set fermentation temperature as figures and other various methods may be provided.

The fermentation condition setting part 45 may further include a fermentation time setting button 47a to input fermentation time; and a set time display part 47b. For example, a user may set the fermentation temperature as 22° C. through the fermentation temperature setting button 46a to proceed fermentation of kimchi by setting the fermentation time as 29 hours. The configuration and display of the fermentation time setting button 47a and the set time display 47b is not limited to the example shown in FIG. 3. Alternatively, the fermentation time setting button 47a and the set time display 47b may be provided in various ways like the fermentation temperature setting button 46a and the set temperature display part 46b.

Meanwhile, the initial fermentation conditions vary according to food to be fermented. For example, the fermentation temperature may be fixed to a single value or include several values according to the fermentation time. That is, cabbage kimchi may be fermented for 29 hours at 22° C., or fermented for 15 hours at 22° C. and then for 5 hours at 25° C. Also, the cabbage kimchi may be fermented at set fermentation temperature alone, without set fermentation time.

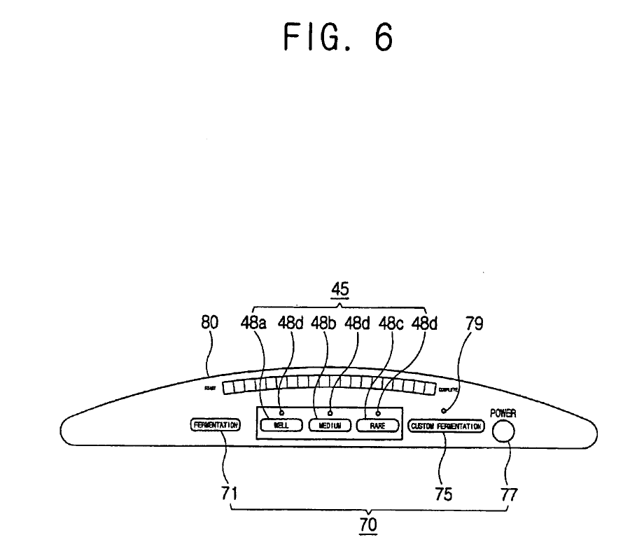

As shown in FIG. 6, the fermentation condition setting part 45 may be provided as automatic fermentation buttons 48a, 48b and 48c which are stored with the fermentation temperature and time in advance according to the kind of the food to be fermented and a desired fermentation level. At this time, the controller 30 may control the fermentation part 60 to ferment food according to the preset fermentation condition by selecting the automatic fermentation buttons 48a, 48b and 48c. An automatic fermentation selection display part 48d may be provided above the automatic fermentation buttons 48a, 48b and 48c to display that one of the automatic fermentation buttons 48a, 48b and 48c is selected.

Referring to FIG. 3, the input part 70 includes a fermentation button 71 to select a fermentation mode operation; a refrigeration button 73 to convert into a refrigeration mode after completing the fermentation of the food; a memory button 75 to memorize a fermentation condition of the fermentation level which meets a user's demand; and a power button 77 to operate the fermentation apparatus 10.

The fermentation button 71 is provided to manually start fermenting food after the initial fermentation conditions are set by the fermentation condition setting part 45 in the fermentation apparatus 10 having the manual fermentation function. If the fermentation button 71 is selected, the fermentation part 60 operates by the controller 30 to heat the storage compartment 50 into the set fermentation temperature.

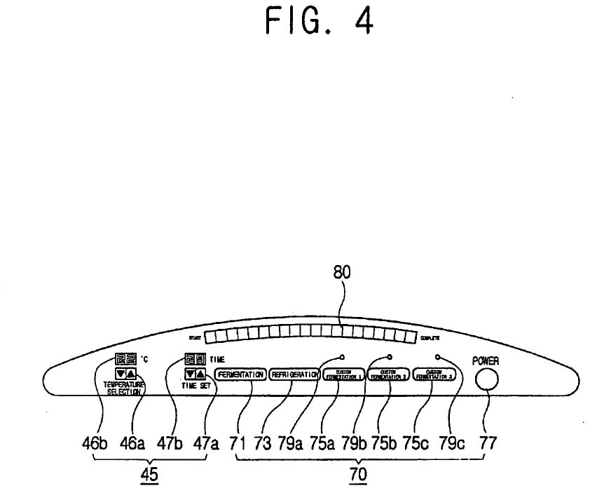

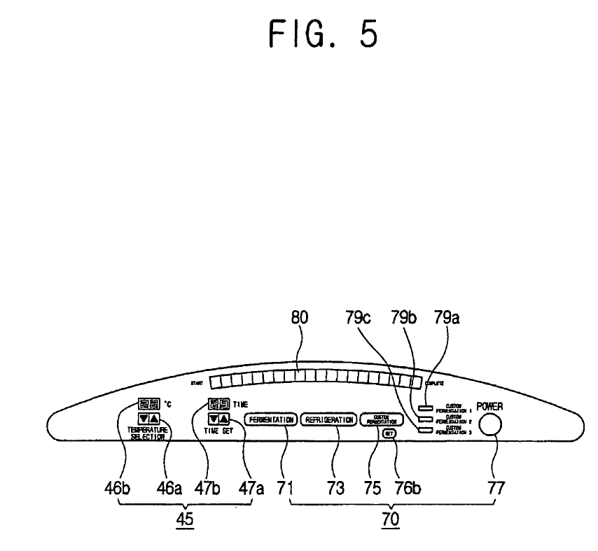

The memory button 75 is selected to memorize when the food reaches a predetermined fermentation level, which a user wants to memorize. If the memory button 75 is selected, the controller 30 stores the entire fermentation time which a timer 25 counts until the memory button 75 is selected and the fermentation temperature at each fermentation time. Here, the number of the memory button 75 may be properly provided according to the number of custom fermentation conditions which a user wants to memorize. FIG. 3 illustrates a single custom fermentation condition, and FIGS. 4 and 5 illustrate three custom fermentation conditions. Alternatively, more than four memory buttons 75 may be provided.

Here, even if the custom fermentation condition is stored by a user through a first memory button 75a, a new fermentation condition may be memorized by selecting the first memory button 75a next time.

Meanwhile, the number of the memory button 75 may not conform to that of storable custom fermentation levels. As shown in FIG. 5, three custom fermentation conditions may be stored by using a selection button 75 available for selecting the custom fermentation condition and a set button 76b for setting the selected custom fermentation condition. With this method, four or more custom fermentation conditions may be stored and displayed.

Referring to FIG. 6, the input part 70 of the fermentation apparatus 10 having the automatic fermentation function may be provided with the plurality of automatic fermentation buttons 48a, 48b and 48c which are set with the fermentation conditions in advance such as “well”, “medium” and “rare”. A display part 48d may be provided above the automatic fermentation buttons 48a, 48b and 48c to display that one of the automatic fermentation buttons 48a, 48b and 48c is selected. The automatic fermentation buttons 48a, 48b and 48c may be provided in various kinds and arrangements including a selection button to select the kind of food to be fermented, apart from the configuration shown in FIG. 6. If a user selects one of the automatic fermentation buttons 48a, 48b and 48c, and wants to memorize the predetermined fermentation level while fermenting the food, then a user may select the memory button 75 to store the predetermined fermentation condition as the custom fermentation condition. Here, the memory button 75 may be plurally provided as necessary. Also, the number and arrangement of the memory button 75 may be provided as shown in FIGS. 4 and 5.

If the custom fermentation condition is stored through the memory button 75, a memory display part 79 is provided to display that the custom fermentation condition is stored by the controller 30. As shown in FIG. 3, the memory display part 79 may be provided above the corresponding memory button 75 as a light emitting diode (LED), which emits light when the memory button 75 is selected, but not limited thereto. As shown in FIG. 4, a memory display part 79 may be provided above each memory button 75. Alternatively, the memory display part 79 may be provided as many as the memorized custom fermentation conditions as shown in FIG. 5, apart from the memory button 75.

The refrigeration button 73 enables a user to manually complete the fermentation mode operation through the controller 30 and convert into the refrigeration mode. If the memory button 75 is selected, the controller 30 may control the fermentation part 60 to complete the fermentation of the food and at the same time convert into the refrigeration mode automatically, without using an additional refrigeration button 73.

If fermenting the same kind of food in the memorized custom fermentation condition after memorizing the foregoing custom fermentation condition, a user may select the memory button 75 corresponding to the desired custom fermentation condition. Then, the controller 30 controls the fermentation part 60 to ferment the food in the memorized fermentation condition, thereby repeatedly providing the food at the desired fermentation level without difficulty.

The controller 30 controls the fermentation part 60 to ferment food according to the set initial fermentation condition, and stores the entire fermentation time which is counted from the start of the fermentation to the selection of the memory button 75 and the fermentation temperature at each fermentation time if the memory button 75 is selected by a user. When the memory button 75 is selected, the controller 30 may automatically convert from the fermentation mode to the refrigeration mode, or manually convert into the refrigeration mode through input of the refrigeration button 73 additionally provided in the input part 70. Alternatively, the controller 30 may keep fermenting food and restore the fermentation condition through selection of the memory button 75 at a new fermentation level. Also, the controller 30 may store the custom fermentation condition in the memory 40.

When the stored custom fermentation condition is selected to perform the custom fermentation, the controller 30 operates the timer 25, and controls the fermentation part 60 to maintain the temperature of the storage compartment 50 at each fermentation time into the fermentation temperature stored as the custom fermentation condition.

Also, the controller 30 may compare the fermentation time of food counted by the timer 25 with the entire fermentation time stored as the custom fermentation condition to determine the fermentation level of the food. If determined that the fermentation time of the food does not reach the entire fermentation time stored as the custom fermentation condition, the controller 30 controls the fermentation part 60 to maintain the fermentation mode. If the fermentation time of the food reaches the entire fermentation time stored as the custom fermentation condition, the controller 30 controls the fermentation part 60 to complete the fermentation of the food and convert into the refrigeration mode. Meanwhile, an additional refrigeration button 73 may be provided in the input part 70 to manually convert from the fermentation mode to the refrigeration mode.

A display part 80 may be provided to display the determined fermentation level of food. At this time, the controller 30 may notify a user the result of the determination through the display part 80.

The controller 30 may store only the entire fermentation time counted by the timer 25 and the set fermentation temperature if the control temperature is uniform during the fermentation process of the food.

An alarm 90 may be provided to notify a user that the fermentation is completed according to the stored custom fermentation condition, by the controller 30. Here, the alarming method of the alarm 90 is not limited. For example, the alarm 90 may be provided as a visual alarm, which turns on and off at predetermined intervals, an auditory alarm to generate predetermined alarming sound or both of which may be used.

As the alarm 90 notifies a user the completion of the fermentation, a user may manually convert into the refrigeration mode, and recognize that the fermentation is completed and the refrigeration mode is operated automatically.

The memory 40 is provided in the main body 15 to make the fermentation condition of the food stored by the controller 30. If the fermentation of the food is started, the fermentation time counted from the timer 25 by the controller 30 and the fermentation temperature at each fermentation time may be stored.

The temperature sensor 21 is provided in the storage compartment 50 to sense the temperature of the storage compartment 50. The temperature sensor 21 may be provided in various kinds, and in various positions to sense the temperature of the storage compartment 50. For example, if an additional storage container is provided to accommodate food in the storage compartment 50, the temperature sensor 21 may be provided in the storage container. According to the sensed result of the temperature sensor 21, the controller 30 controls the fermentation part 60 to maintain the temperature of the storage compartment 50 according to the initial fermentation condition.

The timer 25 is provided in the main body 15 to count time from when the fermentation of the food is started. The counted time is transmitted to the controller 30 to be stored therein, or may be stored in the memory 40 by the controller 30.

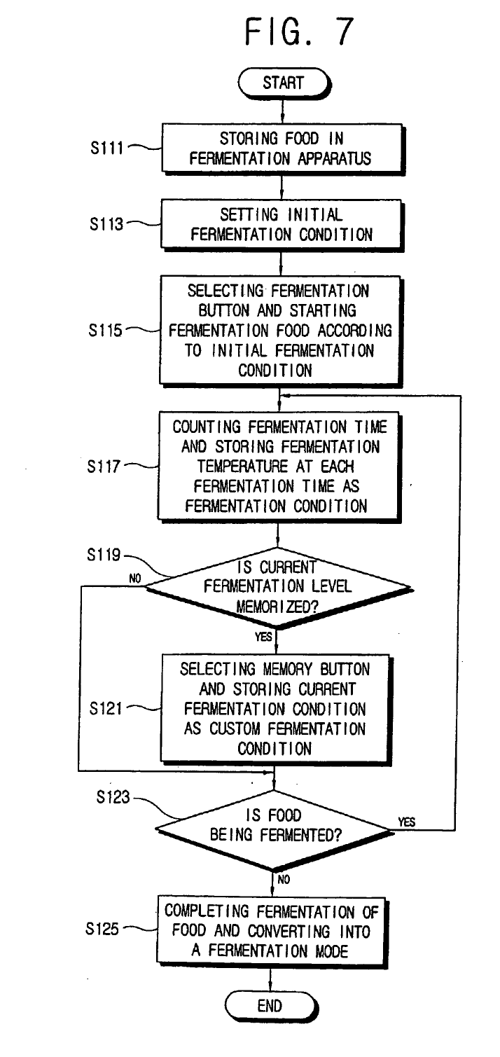

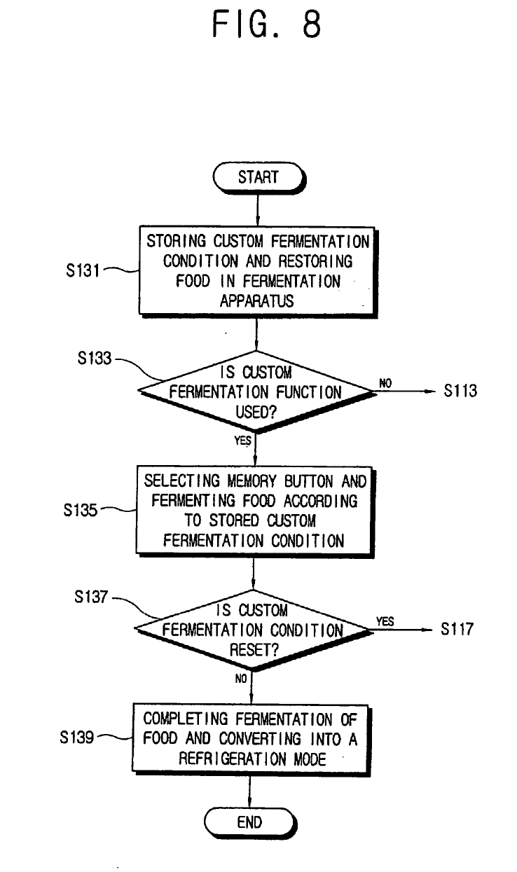

With this configuration, the custom fermentation method of the fermentation apparatus for customizing the fermentation level will be described with reference to FIGS. 7 and 8. FIG. 7 is a flow chart of an initial stage for setting a custom fermentation condition, and FIG. 8 is a flow chart illustrating a method of fermenting food by selecting a set custom fermentation condition.

A user stores food in the storage compartment 50 of the fermentation apparatus 10 to ferment it at operation S111. The initial fermentation condition is set through the fermentation condition setting part 45 before fermenting the food, at operation S113. The initial fermentation condition is set through the fermentation temperature setting button 46a and the fermentation time setting button 47a for the manual fermentation. The automatic fermentation button 48 is selected to set the fermentation condition stored therein in advance as the initial fermentation condition for the automatic fermentation. If the fermentation button 71 provided in the input part 70 is selected, the controller 30 controls the fermentation part 60 to ferment the food in the storage compartment 50 according to the initial fermentation condition at operation S115. If the fermentation of the food is started, the controller 30 operates the timer 25 to count the time from when the fermentation is started, and stores the counted fermentation time and the fermentation temperature at each fermentation time at operation S115. If the fermentation temperature is uniform during the entire fermentation time, the controller 30 does not store each fermentation time and temperature after the fermentation is started, and may store the entire fermentation time when a user selects the memory button 75 and then fermentation temperature only.

A user may set the custom fermentation condition or not, as necessary. If a user does not set the custom fermentation condition, the food is fermented according to the initial fermentation condition and the fermentation apparatus 10 is converted into the refrigeration mode automatically, or converted into the refrigeration mode through input of the refrigeration button 73 to complete the fermentation of the food at operations S119, S123 and S125.

Meanwhile, a user may check the fermentation level of the food while it is fermented. For example, a user may taste, smell or check the fermentation level through the color of the food. If the food reaches the fermentation level which a user wants to memorize at operation S119, a user may select the memory button 75 to memorize it at operation S121. If the memory button 75 is selected, the controller 30 stores the entire fermentation time counted until the memory button 75 is selected and the fermentation temperature at each fermentation time as the custom fermentation condition at operation S121. At this time, the fermentation condition may be stored in the controller 30 or in the memory 40 by the controller 30.

The controller 30 controls the fermentation part 60 to make the fermentation apparatus 10 converted into the refrigeration mode after completing the fermentation of the food through input of the refrigeration button 73 or automatically, at operation S125. If a user wants the food to be continuously fermented, e.g., if a user wants to set the custom fermentation level into various levels or change the stored custom fermentation level, the fermentation may be continued at operation S123.

FIG. 8 is a flow chart of performing the custom fermentation by selecting the set custom fermentation condition. First, the same kind of food as the one which was stored for the custom fermentation is stored in the fermentation apparatus 10 at operation S131. A user may select a preset custom fermentation condition at operation S133, change or restore the custom fermentation condition to proceed with the fermentation at operation S113. At this time, the process shown in FIG. 7 may be performed again.

If a user selects the stored custom fermentation condition, the controller 30 controls the fermentation part 60 to make the food stored in the storage compartment 50 fermented according to the selected custom fermentation condition at operation S135. A user may set a new custom fermentation condition again while fermenting the food according to the custom fermentation condition at operations S137 and S117. At this time, the process shown in FIG. 7 may be performed again to store a new custom fermentation condition.

Meanwhile, the controller 30 may compare the entire fermentation time stored as the custom fermentation condition and the current fermentation time counted by the timer 25 to determine the fermentation level of the food, and display it on the display part 80. If the fermentation time of the food reaches the entire fermentation time stored as the custom fermentation condition, the controller 30 controls the fermentation part 60 to complete the fermentation of the food and refrigerate the food, at operation S139. An alarm 90 may be further provided to visually or audibly notify a user that the fermentation of the food is completed.

When the fermentation of the food is completed, the controller 30 may control the fermentation part 60 to convert the fermentation apparatus 10 into the refrigeration mode through the input of the refrigeration button 73 provided in the input part 70 or automatically, at operation S139.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A fermentation apparatus including a storage compartment which is formed with an accommodating space for storing food, comprising:
a fermentation part to ferment food in the storage compartment;
a fermentation condition setting part to select an initial fermentation condition of the food;
an input part having a memory button to memorize a fermentation condition at a desired fermentation level if the food fermented according to the initial fermentation condition is at the predetermined fermentation level; and
a controller to control the fermentation part, and store fermentation time from the start of the fermentation to the selection of the memory button and fermentation temperature at each fermentation time, as a custom fermentation condition when the memory button is selected.

2. The fermentation apparatus according to claim 1, wherein the fermentation condition setting part comprises:
a fermentation temperature setting button to set the fermentation temperature of the food; and
a fermentation time setting button to set the fermentation time of the food.

3. The fermentation apparatus according to claim 1, wherein the fermentation condition setting part comprises an automatic fermentation button which is stored with the fermentation time according to the kind of the food and a desired fermentation level and the fermentation temperature according to the fermentation time.

4. The fermentation apparatus according to claim 1, further comprising a memory display part to display that the custom fermentation condition is stored, wherein the controller controls the memory display part to display that the custom fermentation condition is stored when the memory button is selected.

5. The fermentation apparatus according to claim 4, wherein the controller stores a plurality of custom fermentation conditions.

6. The fermentation apparatus according to claim 5, wherein the input part is provided with the memory button and the memory display part corresponding to the number of the stored custom fermentation conditions.

7. The fermentation apparatus according to claim 5, wherein the input part is provided with a memory button and a plurality of memory display parts corresponding to the number of the custom fermentation conditions.

8. The fermentation apparatus according to claim 1, wherein the controller controls the fermentation part to complete the fermentation of the food and convert it into a refrigeration mode when the memory button is selected.

9. The fermentation apparatus according to claim 1, wherein the fermentation part comprises at least one of a heating part to heat the storage compartment and a cooling part to cool the storage compartment.

10. The fermentation apparatus according to claim 1, further comprising:
a temperature sensor to sense temperature of the storage compartment; and
a timer to count the fermentation time of the food stored in the storage compartment,
wherein the controller controls the fermentation part to ferment the food according to the custom fermentation condition on the basis of a result sensed by the temperature sensor and the fermentation time counted by the timer if selecting the custom fermentation condition with the memory button.

11. The fermentation apparatus according to claim 10, wherein the controller controls the fermentation part to automatically convert the food into the refrigeration mode if the fermentation of the food is completed according to the custom fermentation condition.

12. The fermentation apparatus according to claim 11, further comprising an alarm to notify a user that the fermentation of the food is completed by the controller if the fermentation of the food is completed according to the custom fermentation condition.

13. A fermentation apparatus including a storage compartment which is formed with an accommodating space for storing food, comprising:
a fermentation part to ferment food in the storage compartment;
a fermentation condition setting part to select an initial fermentation condition of the food;
an input part having at least one memory button to memorize a fermentation condition at a predetermined fermentation level if the food fermented according to the initial fermentation condition is at the predetermined fermentation level;
a memory to be stored with the fermentation condition; and
a controller to control the fermentation part, and store fermentation time from the start of the fermentation to the selection of the memory button and fermentation temperature at each fermentation time, as a custom fermentation condition, in the memory when the memory button is selected.

14. The fermentation apparatus according to claim 13, wherein the fermentation condition setting part comprises at least one of a fermentation temperature setting button and an automatic fermentation button.

15. The fermentation apparatus according to claim 14, further comprising a memory display part to display that the custom fermentation condition is stored in the memory, wherein the controller displays on the memory display part that the custom fermentation condition is stored when the memory button is selected.

16. The fermentation apparatus according to claim 13, further comprising a memory display part to display that the custom fermentation condition is stored in the memory, wherein the controller displays on the memory display part that the custom fermentation condition is stored when the memory button is selected.

17. The fermentation apparatus according to claim 13, wherein the memory is stored with a plurality of custom fermentation conditions by the controller.

18. The fermentation apparatus according to claim 13, wherein the controller controls the fermentation part to complete the fermentation of the food and convert it into a refrigeration mode when the memory button is selected.

19. The fermentation apparatus according to claim 13, wherein the fermentation part comprises at least one of a heating part to heat the storage compartment and a cooling part to cool the storage compartment.

20. The fermentation apparatus according to claim 13, further comprising a temperature sensor to sense temperature of the storage compartment and a timer to count the fermentation time of the food stored in the storage compartment, wherein the controller controls the fermentation part to ferment the food according to the custom fermentation condition on the basis of a result sensed by the temperature sensor and the fermentation time counted by the timer if selecting the custom fermentation condition with the memory button.

21. The fermentation apparatus according to claim 20, wherein the controller controls the fermentation part to automatically convert the food into the refrigeration mode if the fermentation of the food is completed according to the custom fermentation condition.

22. The fermentation apparatus according to claim 20, further comprising an alarm to notify a user that the fermentation of the food is completed by the controller if the fermentation of the food is completed.

23. A custom fermentation method to memorize fermentation time and fermentation temperature of food at each fermentation time and store them as a custom fermentation condition, comprising:
storing food in a storage compartment to ferment it;
setting the fermentation time and temperature as an initial fermentation condition of the food in the storage compartment;
fermenting the food in the storage compartment according to the initial fermentation condition;
counting the fermentation time of the food and storing the fermentation temperature at each fermentation time as the fermentation condition;
selecting a memory button to memorize the fermentation condition at each fermentation level if the food reaches a predetermined fermentation level; and
storing the fermentation condition as the custom fermentation condition when the memory button is selected.

24. The custom fermentation method according to claim 23, further comprising completing the fermentation of the food and converting into a refrigeration mode automatically when the memory button is selected.

25. The custom fermentation method according to claim 23, further comprising:
restoring food in the storage compartment to ferment it;
selecting the stored custom fermentation condition through the memory button; and
fermenting the food in the storage compartment according to the custom fermentation condition.

26. The custom fermentation method according to claim 25, further comprising completing the fermentation of the food and converting into the refrigeration mode automatically if the fermentation of the food is completed according to the custom fermentation condition.

27. The custom fermentation method according to claim 25, further comprising notifying a user that the fermentation of the food is completed.
